(19) United States
(12) Patent Application Publication
(10) Pub. No.: US 2004/0263072 A1
(43) Pub. Date: Dec. 30, 2004

(54) Flat panel display

(76) Inventors: Joon-Young Park, Seoul (KR); Jun-Yeob Lee, Seongnam-si (KR); Jae-Jung Kim, Hwaseong-gun (KR); Yong-Joong Choi, Yongin-si (KR); Mi-Sook Suh, Yongin-si (KR)

Correspondence Address: MCGUIREWOODS, LLP, 1750 TYSONS BLVD, SUITE 1800, MCLEAN, VA, 22102, US

(21) Appl. No.: 10/873,169

(22) Filed: Jun. 23, 2004

(30) Foreign Application Priority Data
Jun. 24, 2003 (KR) 2003-41222
Apr. 8, 2004 (KR) 2004-24018

(51) Int. Cl. H05B 33/00; H05B 33/14

(52) U.S. Cl. 313/509; 313/503; 313/504; 313/506

(57) ABSTRACT

A flat panel display is provided. The flat panel display includes a substrate, a plurality of first electrodes formed on the substrate, a plurality of insulating layers formed on the substrate, a second electrode insulatingly opposite the first electrodes, and a plurality of organic emission layers interposed between the first electrodes and the second electrode and emitting light by driving of the first electrodes and the second electrode, wherein a region having the insulating layers and an opening region absent of the insulating layers are located between or outside the first electrodes. Using this configuration, damage to the organic emission layers by a gas emitted from the insulating layers can be minimized.

### BACKGROUND OF THE INVENTION

This application claims the priority of Korean Patent Application No. 2003-41222 filed on Jun. 24, 2003 and No. 2004-24018 filed on Apr. 8, 2004, in the Korean Intellectual Property Office, which are incorporated herein by reference.

1. Field of the Invention

The present invention relates to a flat panel display, and more particularly to a flat panel display with an improved insulating layer.

2. Description of the Related Art

Generally, flat panel displays are largely classified into a light-emitting type and a light-receiving type. Examples of light-emitting flat panel displays include flat cathode ray tubes, plasma display panels, electroluminescent devices, and light-emitting diodes. Liquid crystal displays are illustrative of light-receiving flat panel displays.

Since electroluminescent displays offer advantages such as wide viewing angle, high contrast, and fast response speed, there has been an increasing interest in developing them as next generation displays. Electroluminescent displays are classified as inorganic and organic electroluminescent displays according to whether a light emission layer is made of an inorganic material or an organic material.

In particular, the organic electroluminescent displays are self-emission type displays that emit light by electrical excitation of an organic fluorescent compound. Such displays have many advantages over liquid crystal displays such as low driving voltage, easy thin layer formation, wide viewing angle, and fast response speed.

Organic electroluminescent displays generally include a light emission layer made of an organic material interposed between an anode and a cathode. When an anode voltage and a cathode voltage are respectively applied to the anode and the cathode, electron holes (hereinafter “hole” or “holes”) from the anode transfer into the light emission layer through a hole transport layer, and electrons from the cathode transfer into the light emission layer through an electron transport layer. Thereafter, the holes and electrons recombine with each other in the light emission layer to generate excitons.

As excitons change from an excited state to a ground state, fluorescent molecules in the light emission layer emit light, thereby displaying an image. Full-color type organic electroluminescent displays include red (R), green (G), and blue (B) light-emitting pixels to display a full color image.

In flat panel displays such as electroluminescent displays and liquid crystal displays, a thin film transistor (hereinafter, referred to as “TFT”) is used as a pixel-switching element and a pixel-driving element. The TFT generally includes a semiconductive active layer having a drain region and a source region doped with an impurity at a high concentration on a substrate, a channel region connecting the drain and source regions, a gate insulating layer disposed on the semiconductive active layer, and a gate electrode disposed on the gate insulating layer corresponding to the channel region of the semiconductive active layer. Active matrix organic electroluminescent displays (AMOELD) include at least two TFTs per each pixel. Examples of past AMOELDs are provided in U.S. Pat. Nos. 5,742,129, 6,194,837, 6,373,453, and 6,380,672.

A conventional active matrix organic electroluminescent display 10 is shown in FIG. 1. In the active matrix organic electroluminescent display 10, the remaining regions of pixels, except light emission regions above first electrodes 11, are covered with a planarization layer 12.

Referring to FIG. 1, in the active matrix organic electroluminescent display 10, after light emission layers made of an organic material are formed on the first electrodes 11, a second electrode (not shown) commonly covering all the light emission regions is formed. In this case, due to height differences between a substrate region having various data and driving lines thereon and the remaining substrate region, the second electrode is unevenly formed.

That is, due to an uneven structure below the second electrode, the second electrode formed on the uneven structure cannot have a flattened shape. For this reason, the second electrode exhibits an electrically unstable phenomenon upon driving. In this regard, the active matrix organic electroluminescent display 10 generally has the planarization layer 12 made of an organic material.

The planarization layer 12 is formed to a thickness larger than the height of the data and driving lines to overcome the height difference due to the data and driving lines. The photoresist of portions of the planarization layer 12 corresponding to the light emission regions above the first electrodes 11 is removed in a photolithography process to expose the first electrodes 11. All substrate regions except the first electrodes 11 are covered with the planarization layer 12. The planarization layer 12 is generally formed along the edges of the first electrodes 11.

A significant drawback associated with the conventional active matrix organic electroluminescent display 10 is than when the display is driven, an organic gas is emitted from the planarization layer 12 used for stabilization of the second electrode.

The organic gas present in the planarization layer 12 is mainly generated by photoreaction of photoactive compounds (PACs) during patterning of the planarization layer 12. Examples of the organic gas include benzaldehyde, benzyl alcohol, and a benzene compound such as toluene and xylane. Over time, this gas permeates and adversely affects a light emission layer made of an organic material. In particular, even when an external temperature is slightly raised, a luminance at peripheral portions A of pixels adjacent to the planarization layer 12 becomes lower than that at central portions B of the pixels, as shown in FIG. 2. The peripheral portions A of the pixels become gradually darker than the central portions B with time, thereby decreasing effective emission areas of the light emission regions. This pixel-reduction phenomenon worsens as the area of the planarization layer 12 around the pixels becomes larger.

### SUMMARY OF THE INVENTION

A flat panel display is disclosed and claimed. In one embodiment, the flat panel display, includes substrate having a protective layer formed thereon. A first pixel electrode is formed on the protective layer, and an organic emission layer contacts the first pixel electrode. A first insulating layer is formed adjacent to the first pixel electrode, and a portion of the first insulating layer contacts the first pixel electrode. A second insulating layer is formed on the protective layer and separated from the first insulating layer by an opening. A second electrode is formed over the first insulating layer and the second insulating layer, and a portion of the second electrode contacts the organic emission layer. The opening may vary in width and is configured to release a gas emitted from the first insulating layer or the second insulating layer to protect the organic emission layer from gas permeation damage.

In one embodiment, the first insulating layer is formed in a closed-curve shape about the first pixel electrode. Additionally, the first pixel electrode may be an anode electrode or a cathode electrode, and the second electrode may be a cathode electrode or an anode electrode, respectively. Moreover, the first pixel electrode may be a transparent electrode or a reflective electrode. Similarly, the second electrode may be a transparent cathode electrode or a reflective electrode.

### BRIEF DESCRIPTION OF THE DRAWINGS

FIG. 1 is a schematic view of a conventional organic electroluminescent display;

FIG. 2 is a photograph of a conventional organic electroluminescent display;

FIG. 3 is a plan view of an organic electroluminescent display according to a first embodiment of the present invention;

FIG. 4 is a schematic view of the organic electroluminescent display of FIG. 3;

FIG. 5 is a schematic view of an array of first electrodes in the organic electroluminescent display of FIG. 4;

FIG. 6 is a schematic view of an array of first electrodes in an organic electroluminescent display according to a second embodiment of the present invention;

FIG. 7 is a schematic view of an array of first electrodes in an organic electroluminescent display according to a third embodiment of the present invention;

FIG. 8 is a schematic view of an array of first electrodes in an organic electroluminescent display according to a fourth embodiment of the present invention;

FIG. 9 is a schematic view of an array of first electrodes in an organic electroluminescent display according to a fifth embodiment of the present invention; and

FIG. 10 is a schematic view of an array of first electrodes in an organic electroluminescent display according to a sixth embodiment of the present invention.

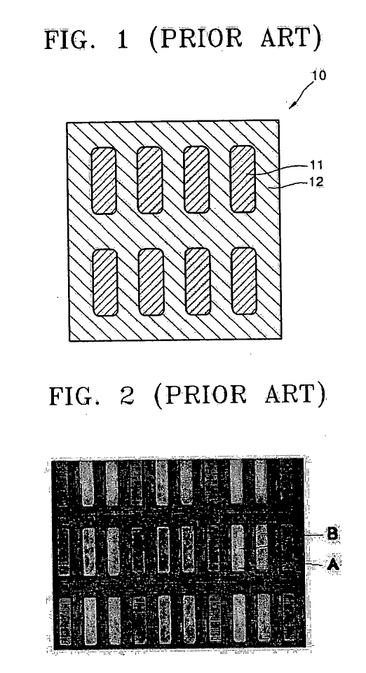

### DETAILED DESCRIPTION OF THE INVENTION

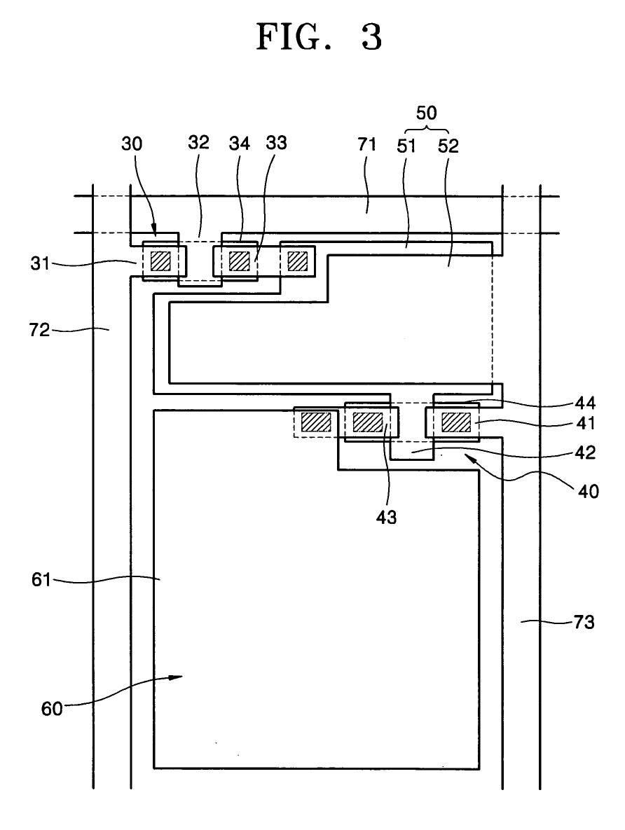

Referring now to FIG. 3, there is shown the structure of a pixel of an active matrix organic electroluminescent display according to a first embodiment of the present invention. In particular, FIG. 3 is a partially enlarged view of one of a plurality of red, green, or blue pixels that constitute a driving unit in an organic electroluminescent flat panel display.

In this first embodiment, the organic electroluminescent display has red, green, and blue pixels. Various array patterns such as a mosaic-type or lattice-type array of individual color pixels are possible. These pixels are arranged in a display region (not shown) of the organic electroluminescent display to create a predetermined image. As shown, each pixel of the display region includes a selective driving circuit with a switching TFT 30, a driving TFT 40, and a capacitor 50 and an organic electroluminescent element 60 used as a light emission element. Although not depicted in FIG. 3, various driving circuits and terminals connected to external powers and electronic devices are positioned around the display region. The display region is sealed so as not to be exposed to external air.

As described above, each of the pixels of the active matrix organic electroluminescent display includes a selective driving circuit having two TFTs (i.e., the switching TFT 30 and the driving TFT 40), a capacitor 50, and an organic electroluminescent element 60. Since there is no limitation on the number of TFTs and capacitors of the selective driving circuit, more TFTs and capacitors according to a desired design of the organic electroluminescent element may be used.

In use, the switching TFT 30, driven by a scan signal applied to a gate line 71, transmits a data signal applied to a data line 72 to the capacitor 50. The driving TFT 40 serves to determine the amount of current to be injected into the organic electroluminescent element 60 according to the data signal transmitted by the capacitor 50, i.e., a voltage difference (Vgs) between a gate and a voltage source. A data signal transmitted by the switching TFT 30 during one frame is stored by the capacitor 50.

A source electrode 31 of the switching TFT 30 is connected to a driving circuit through the data line 72, and a gate electrode 32 of the switching TFT 30 is connected to another driving circuit through the gate line 71. A drain electrode 33 of the switching TFT 30 is connected to a first capacitor electrode 51 of the capacitor 50 and a gate electrode 42 of the driving TFT 40.

A second capacitor electrode 52 of the capacitor 50 and a source electrode 41 of the driving TFT 40 are connected to a driving line 73, and a drain electrode 43 of the driving TFT 40 is connected to a first electrode 61 of the organic electroluminescent element 60.

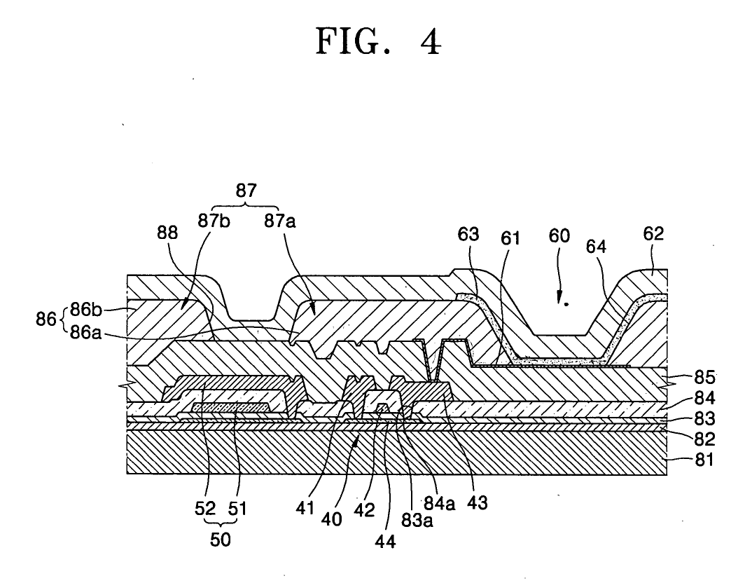

The organic electroluminescent element 60 includes the first electrode 61 used as a pixel electrode, a second electrode 62 used as a common electrode which is oppositely separated from the first electrode 61 by a predetermined gap, and an organic emission layer 63 interposed between the first and second electrodes 61 and 62 and emitting light by driving of the first and second electrodes 61 and 62, as shown in FIG. 4.

In the embodiment shown in FIG. 4, an active matrix organic electroluminescent display includes a substrate 81. The substrate 81 may be made of a transparent material, such as a glass or a plastic material. A buffer layer 82 is formed on the entire surface of the substrate 81.

The switching TFT 30, the driving TFT 40, the capacitor 50, and the organic electroluminescent element 60 shown in FIG. 3 are formed on the buffer layer 82; however, the switching TFT 30 of FIG. 3 is not shown in FIG. 4.

An active layer 44 is formed in a predetermined pattern on the buffer layer 82. The active layer 44 is buried in a gate insulating layer 83. The active layer 44 may be made of a p- or n-type semiconductor material.

The gate electrode 42 of the driving TFT 40 is formed on the gate insulating layer 83 corresponding to the active layer 44. The gate electrode 42 is buried in an inter-insulating layer 84. Subsequent to the formation of the inter-insulating layer 84, the gate insulating layer 83 and the inter-insulating layer 84 are subjected to etching such as dry etching to form contact holes 83a and 84a. As a result, portions of the active layer 44 are exposed.

The exposed portions of the active layer 44 are connected to the source electrode 41 and the drain electrode 43 of the driving TFT 40 that are formed in a predetermined pattern, through the contact holes 83a and 84a. The source electrode 41 and the drain electrode 43 are buried in a protective layer 85. A portion of the protective layer 85 is etched to expose a portion of the drain electrode 43.

The protective layer 85 is made of an insulating material and may be an inorganic layer made of silicon oxide or silicon nitride or an organic layer made of acryl or benzocyclobutene (BCB). A separate insulating layer may be formed on the protective layer 85 to level the protective layer 85.

An organic electroluminescent element 60 includes a first electrode 61, a second electrode 62, and an organic emission layer 63. The first electrode 61 is used as a pixel electrode and is electrically connected to the drain electrode 43 of the driving TFT 40. The second electrode is used as an opposite electrode to the first electrode 61 and may cover whole pixels. The organic emission layer 63 is interposed between the first electrode 61 and the second electrode 62, and emits red, green, or blue light according to the amount of current received from the first and second electrodes.

In the embodiment shown, the first electrode 61 is patterned on the protective layer 85, and is covered with an insulation layer 86. After a predetermined pixel opening 64 is formed in the insulating layer 86, the second electrode 62 is formed on the organic emission layer 63. The first electrode 61 and the second electrode 62 are insulated from each other and receive opposite voltages so that the organic emission layer 63 emits light.

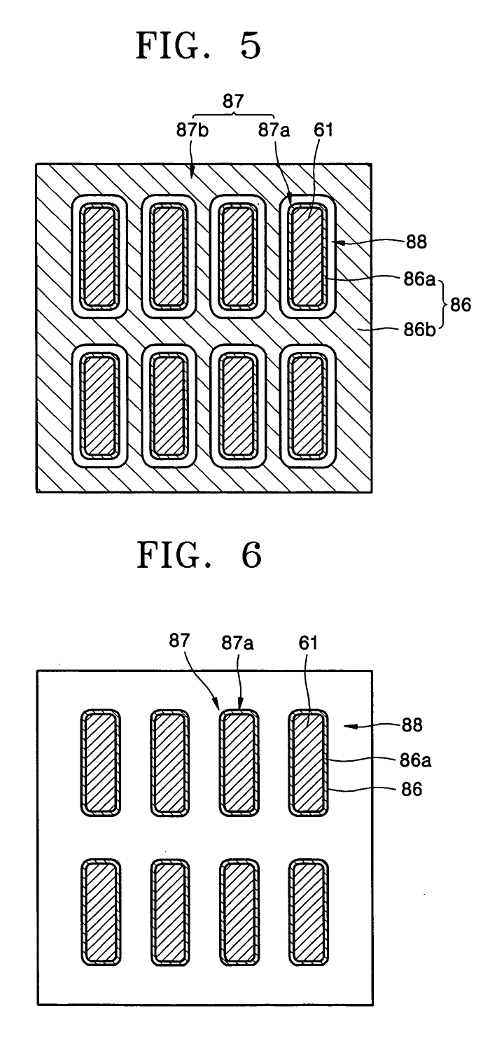

As shown in FIG. 5, the insulating layer 86 also serves as a pixel defining layer, and is made of an organic material. Additionally, the insulating layer 86 serves to level the surface of the substrate on which the first electrode 61 is formed, in particular the surface of the protective layer 85. The insulating layer 86 is further described in detail, below.

The organic emission layer 63 may be a non-polymer or polymer organic layer. The non-polymer organic layer may have a simple- or multi-laminated structure of a hole injection layer (HIL), a hole transport layer (HTL), an emission layer (EML), an electron transport layer (ETL), and an electron injection layer (EIL). A non-polymer organic material to be used for the organic emission layer may be copper phthalocyanine (CuPc), N,N-di(naphthalene-1-yl)-N,N′-diphenyl benzidine (NPB), or tris-8-hydroxyquinoline aluminum (Alq3). The non-polymer organic layer may be formed by vacuum deposition.

The polymer organic layer may have a structure comprised of a hole transport layer (HTL) and an emission layer (EML). In this case, the hole transport layer may be made of poly(ethylenedioxy)thiophene (PEDOT) and the emission layer may be made of a high molecular weight organic material such as poly(phenylene vinylene) (PPV) and polyfluorene. The hole transport layer and the emission layer may be formed by screen printing or ink-jet printing.

The structure of the organic emission layer 63 of the present invention is not limited to that as described above. It is understood that the organic emission layer 63 of the present invention can have any structure provided that the objects of the present invention can be accomplished.

The first electrode 61 may be an anode and the second electrode 62 may be a cathode. Of course, the first electrode 61 may be a cathode and the second electrode 62 may be an anode. The first electrode 61 may be patterned correspondingly to each pixel and the second electrode 62 may covers multiple pixels.

The first electrode 61 may be a transparent electrode or a reflective electrode. When the first electrode 61 is a transparent electrode, transparent conductive materials such as Indium Tin Oxide (ITO), Indium Zinc Oxide (IZO), Zinc Oxide (ZnO), or Indium Oxide (In₂O₃) may be used. When the first electrode 61 is a reflective electrode, a transparent electrode layer made of ITO, IZO, ZnO, or In₂O₃ may be formed on a reflective layer made of Silver (Ag), Magnesium (Mg), Aluminium (Al), Platinum (Pt), Palladium (Pd), Gold (Au), Nickel (Ni), Neodymium (Nd), Iridium (Ir), Chromium (Cr), or a compound thereof.

The second electrode 62 may be a transparent electrode or a reflective electrode. Because the second electrode 62 is used as a cathode when it is a transparent electrode, after a small work function metal, i.e., Lithium (Li), Calcium (Ca), Lithium Fluoride/Calcium (LIF/Ca), Lithium Fluoride (LiF/Al), Aluminium (Al), Silver (Ag), Magnesium (Mg), or a compound thereof is deposited on the organic emission layer 63, an auxiliary electrode layer or a bus electrode line made of ITO, IZO, ZnO, or In₂O₃ may be formed thereon. When the second electrode 62 is a reflective electrode, Li, Ca, LiF/Ca, LiF/Al, Al, Ag, Mg, or a compound thereof may be used.

A region 87 having the insulating layer 86 and an opening region 88 absent of the insulating layer 86 are located between or outside the first electrode 61 patterns. The region 87 having the insulating layer 86 is also referred to as a planarized region, hereinafter. However, the region 87 having the insulating layer 86 is not limited to the meaning of the term “planarized region” and it is understood that the insulating layer 86 does not necessarily have a planarization function.

To compensate for a height difference due to the individual patterns of the switching TFT 30, the driving TFT 40, and the capacitor 50 that are formed on the substrate 81, the insulating layer 86 may be formed everywhere on the substrate 81 except the pixel opening 64 of the organic electroluminescent element 60. In one embodiment, the insulating layer 86 is formed subsequent to the formation of the first electrode 61 on the protective layer 85. The insulating layer 86 may be made of an organic material such as acryl or BCB (but is not limited thereto), or of an inorganic material. Additionally, the insulating layer 86 may have various structures according to the surface state of the substrate 81 or protective layer 85 on which the insulating layer 86 is formed.

The planarized region 87 having the insulting layer 86 includes a first region 87a having a first insulating layer 86a. A portion of the first insulating layer 86a is overlapped with at least an edge of the first electrode 61. As shown in FIG. 5, the first insulating layer 86a may be formed in a thin closed curve shape along the edge of the first electrode 61.

The first insulating layer 86a is formed along the edge of the first electrode 61. A second region 87b is separated from the first region 87a by a predetermined distance and includes a second insulating layer 86b. The opening region 88 is absent of the insulating layer 86 and is located between the first region 87a and the second region 87b.

The first region 87a may have a width of approximately 1 μm to approximately 15 μm. When the organic emission layer 63 and the second electrode 62 are sequentially formed on the first electrode 61, this first region 87a serves to prevent the generation of white spots or dark spots caused by a short-circuit between the first electrode 61 and the second electrode 62.

The opening region 88 (absent of insulating material) present along the edge of the first region 87a serves to decrease damage to the organic emission layer 63 by releasing a gas from the insulating layer 86 when the organic electroluminescent display is operated.

In the embodiment shown in FIG. 5, the opening region 88, formed to a predetermined width along the edge of the first electrode 61, serves as a buffer region for releasing a gas from the insulating layer 86.

By releasing gas emitted from the insulating layer 86 during operation of the organic electroluminescent display, the opening region 88 can retard a pixel reduction rate over time, as compared to the case where the opening region 88 is absent. In one embodiment, the opening region 88 is formed to a width of approximately 1 μm to approximately 15 μm.

The second region 87b having the second insulating layer 86b is formed outside the opening region 88. The second insulating layer 86b of the second region 87b is made of substantially the same material as the first insulating layer 86a. The second region 87b serves to level the substrate 81, in particular the protective layer 85, to prevent degradation due to steps between the first electrode 61 and peripheral power lines in active matrix-type displays.

In this way, the planarized region 87 includes the first region 87a formed to a predetermined width along the edge of the first electrode 61 and the second region 87b separated from the first region 87a by the opening region 88.

Due to the opening region 88, the area of the insulating layer 86 (i.e., the sum of the area of the first region 87a and the area of the second region 87b) is smaller than the area of the substrate of the active matrix organic electroluminescent display except for a light emission region intended for light emission by the organic emission layer 62, i.e., the pixel opening 64.

A second embodiment of the present invention as shown in FIG. 6. In this second embodiment, a planarized region 87 has an insulating layer 86 and includes a first region 87a that has a first insulating layer 86a formed along the edge of a first electrode 61 so that an opening region 88 is present on the entire surface of a substrate outside the first region 87a.

In this manner, the insulating layer 86 is formed in a thin band shape along the edge of the first electrode 61. The opening region 88 is present on the entire surface of the substrate outside the insulating layer 86 to prevent a gas emitted from the insulating layer 86 from damaging an organic emission layer.

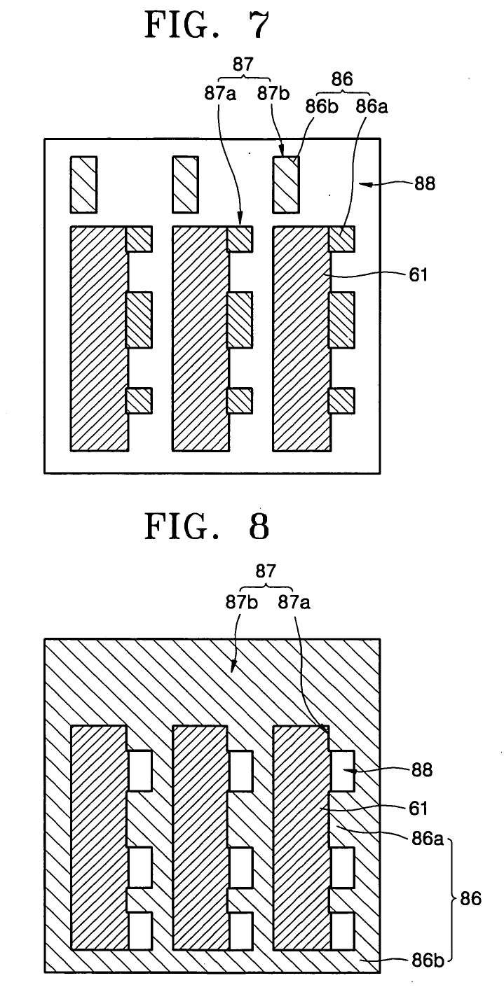

A third embodiment of the present invention is shown in FIG. 7. In this third embodiment, a planarized region 87 has an insulating layer 86 and includes a first region 87a that has both a first insulating layer 86a formed discontinuously along the edge of a first electrode 61 and a second region 87b which includes a second insulating layer 86b formed on a high height difference region of a substrate or a protective layer. Because the amount of gas emitted is roughly proportional to the area of the insulating layer 86, reducing the area of the insulating area 86 effectively minimizes gas damage to the organic emission layer.

A fourth embodiment of the present invention is shown in FIG. 8. In this fourth embodiment, the planarized region 87 has an insulating layer 86 and includes not only a first region 87a which has a first insulating layer 86a formed discontinuously along the edge of the first electrode 61, and an opening region 88 present outside the first region 87a, but also a second region 87b which has a second insulating layer 86b present outside the opening region 88. In this embodiment, the first region 87a and the second region 87b are partially connected to each other. As shown, the first electrode 61 is slightly connected to the insulating layer 86, and only the area of a substrate outside the first electrode 61 is covered with the insulating layer 86. In this manner, gas penetration into a light emission region is prevented.

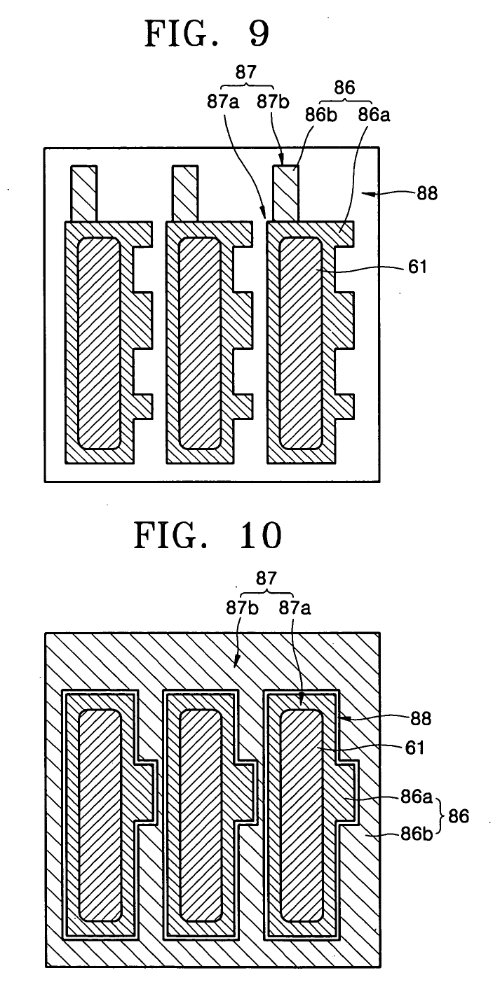

A fifth embodiment of the present invention is shown in FIG. 9. In this fifth embodiment, the planarized region 87 has an insulating layer 86 and includes both a first region 87a that has a first insulating layer 86a formed in a closed curve shape along the edge of a first electrode 61 and a second region 87b which has a second insulating layer 86b formed on a high height difference region of a substrate or a protective layer outside the first region 87a. The first region 87a and the second region 87b are connected to each other. An opening region 88 is present outside the first region 87a and the second region 87b. In this embodiment, the first insulating layer 86a of the first region 87a serves to prevent a short-circuit between the first electrode 61 and a second electrode (not shown), while the second insulating layer 86b of the second region 87b serves to level the substrate or protective layer. Furthermore, the enlargement of the opening region 88, in this embodiment, protects pixels from being permeated by gas emitted from the insulating layer 86 when the display is operated.

A sixth embodiment of the present invention, shown in FIG. 10, has the same fundamental structure as the first embodiment as shown in FIG. 5 except that the width of the first insulating layer 86a of the first region 87a varies depending on the surface state of the substrate or protective layer.

It is understood that the above-described structure of an insulating layer is commonly applied to passive matrix organic electroluminescent displays containing no selective driving circuits, and to active matrix organic electroluminescent displays containing a selective driving circuit per each pixel.

Until now, the present invention has been described in terms of an active matrix organic electroluminescent display. However, it is understood that the present invention can also be applied to TFT, circuit-containing, liquid crystal displays, to inorganic electroluminescent displays, to TFT, circuit-free, flat panel displays.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A flat panel display comprising:
a substrate;
a plurality of first electrodes formed on the substrate;
a plurality of insulating layers formed on the substrate;
a second electrode insulatingly opposite to the first electrodes; and
a plurality of organic emission layers interposed between the first electrodes and the second electrode and emitting light by driving of the first electrodes and the second electrode,
wherein a region having the insulating layers and an opening region absent of the insulating layers are located between or outside the first electrodes.

2. The flat panel display of claim 1, wherein the region having the insulating layers comprises a first region having first insulating layers, at least a portion of each of which is formed on at least a portion of each of the first electrodes.

3. The flat panel display of claim 2, wherein the area of the first region is smaller than the area of non-emission regions of the substrate except light emission regions intended for light emission by the organic emission layers.

4. The flat panel display of claim 2, wherein the opening region is present outside the first region.

5. The flat panel display of claim 2, wherein the region having the insulating layers comprises a second region having second insulating layers that are not formed on the first electrodes.

6. The flat panel display of claim 5, wherein the sum of the area of the first region and the area of the second region is smaller than the area of non-emission regions except light emission regions intended for light emission by the organic emission layers.

7. The flat panel display of claim 5, wherein the opening region is present between the first region and the second region.

8. The flat panel display of claim 7, wherein the first insulating layers are formed in closed curve shapes surrounding the first electrodes.

9. The flat panel display of claim 7, wherein the first insulating layers have a width of about 1 to 15 μm.

10. The flat panel display of claim 7, wherein the opening region has a width of about 1 to 15 μm.

11. The flat panel display of claim 5, wherein the first region and the second region are separated from each other.

12. The flat panel display of claim 5, wherein at least a portion of the first region is connected to at least a portion of the second region.

13. The flat panel display of claim 5, wherein the opening region is present between the first electrodes and the second region.

14. The flat panel display of claim 5, wherein the opening region is present outside the first region and the second region.

15. The flat panel display of claim 2, wherein the first insulating layers have a width of about 1 to 15 μm.

16. The flat panel display of claim 1, wherein the region having the insulating layers comprises a second region having second insulating layers that are not formed on the first electrodes.

17. The flat panel display of claim 16, wherein the opening region is present between the first electrodes and the second region.

18. The flat panel display of claim 16, wherein the opening region is present outside the second region.

19. The flat panel display of claim 1, wherein the opening region has a width of about 1 to 15 μm.

20. The flat panel display of claim 1, wherein the insulating layers are made of an organic material.

21. A flat panel display comprising:
a substrate; and
a display region formed on the substrate and having a plurality of pixels,
wherein the display region comprises:
a plurality of selective driving circuits formed in each of the pixels;
a protective layer made of an insulating material and covering the selective driving circuits;
a plurality of pixel electrodes formed on the protective layer in each of the pixels; and
a plurality of insulating layers formed on the protective layer, and
wherein a region having the insulating layers and an opening region absent of the insulating layers are located between or outside the pixel electrodes.

22. The flat panel display of claim 21, wherein the region having the insulating layers comprises a first region having first insulating layers, at least a portion of each of which is formed on at least a portion of each of the pixel electrodes.

23. The flat panel display of claim 22, wherein the area of the first region is smaller than the area of non-emission regions of the display region.

24. The flat panel display of claim 22, wherein the opening region is present outside the first region.

25. The flat panel display of claim 22, wherein the region having the insulating layers comprises a second region having second insulating layers that are not formed on the pixel electrodes.

26. The flat panel display of claim 25, wherein the sum of the area of the first region and the area of the second region is smaller than the area of non-emission regions of the display region.

27. The flat panel display of claim 25, wherein the opening region is present between the first region and the second region.

28. The flat panel display of claim 27, wherein the first insulating layers are formed in closed curve shapes surrounding the pixel electrodes.

29. The flat panel display of claim 27, wherein the first insulating layers have a width of about 1 to 15 μm.

30. The flat panel display of claim 27, wherein the opening region has a width of about 1 to 15 μm.

31. The flat panel display of claim 25, wherein the first region and the second region are separated from each other.

32. The flat panel display of claim 25, wherein at least a portion of the first region is connected to at least a portion of the second region.

33. The flat panel display of claim 25, wherein the opening region is present between the pixel electrodes and the second region.

34. The flat panel display of claim 25, wherein the opening region is present outside the first region and the second region.

35. The flat panel display of claim 22, wherein the first insulating layers have a width of about 1 to 15 μm.

36. The flat panel display of claim 21, wherein the region having the insulating layers comprises a second region having second insulating layers that are not formed on the pixel electrodes.

37. The flat panel display of claim 36, wherein the opening region is present between the pixel electrodes and the second region.

38. The flat panel display of claim 36, wherein the opening region is present outside the second region.

39. The flat panel display of claim 21, wherein the opening region has a width of about 1 to 15 μm.

40. The flat panel display of claim 21, wherein the insulating layers are made of an organic material.

41. The flat panel display of any one of claims 21 though 39, wherein each of the pixels comprises an organic electroluminescent element and each of the pixel electrodes is one electrode of the organic electroluminescent element.
